(19) United States
(12) Patent Application Publication
(10) Pub. No.: US 2008/0048569 A1
(43) Pub. Date: Feb. 28, 2008

(54) DIELECTRIC ELEMENT AND ELECTRON EMITTER

(75) Inventors: Kei Sato, Tokai-City (JP); Tetsuya Hattori, Nagoya-City (JP); Hirofumi Yamaguchi, Komaki-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/839,031

(22) Filed: Aug. 15, 2007

(30) Foreign Application Priority Data
Aug. 24, 2006 (JP) 2006-227367

(51) Int. Cl. G09G 3/00; B32B 15/00

(52) U.S. Cl. 315/169.1; 428/640

(57) ABSTRACT

Provided are a dielectric element and an electron emitter exhibiting suppressed deterioration of element characteristics, which deterioration would otherwise occur with repeated use thereof. An electron emitter (i.e., a dielectric element) of the present invention is configured so as to operate through application of a predetermined driving electric field to an emitter layer. The emitter layer is formed of a dielectric layer containing, as a primary component, a PMN-PT-PZ ternary solid solution composition, and having a Curie temperature Tc (° C.) falling within a range of 60≦Tc≦150.

### BACKGROUND OF THE INVENTION

1. Field of the Invention

The present invention relates to a dielectric element including a dielectric layer. The present invention also relates to an electron emitter which is suitably employed as an electron beam source in a variety of devices that utilize electron beams, including a field emission display (FED), an electron beam irradiation device, a light source, an electronic-component-manufacturing device, and an electronic circuit component.

2. Description of the Related Art

Such an electron emitter includes an emitter section which is provided in a reduced-pressure atmosphere having a predetermined vacuum level. The emitter section is configured so that it can emit electrons into the reduced-pressure atmosphere through application of a predetermined driving electric field.

In an FED, a plurality of electron emitters having the aforementioned configuration are two-dimensionally arrayed on a substrate made of, for example, glass or ceramic material. In addition, a plurality of phosphors corresponding to the electron emitters are arrayed with a predetermined gap provided therebetween of the aforementioned reduced-pressure atmosphere. The FED is configured so that electrons emitted from the electron emitters fly through the aforementioned gap and collide with the phosphors, and the phosphors hit by the electrons fluoresce, thereby displaying a desired image.

Known electron emitters having the aforementioned configuration include an electron emitter having an emitter section made of a dielectric material (piezoelectric material). Such an electron emitter is called a “piezoelectric-film-type electron emitter.” This type of electron emitter is produced at low cost, and therefore is suitable for use in an FED, in which, as described above, numerous electron emitters are two-dimensionally arrayed on a substrate having a relatively large area.

A conventionally known piezoelectric-film-type electron emitter is disclosed in, for example, Japanese Patent Application Laid-Open (kokai) No. 2005-183361.

The aforementioned piezoelectric-film-type electron emitter includes an emitter section formed of a dielectric layer, a first electrode, and a second electrode. The first electrode is provided on the top surface of the dielectric layer. The second electrode is provided on the bottom surface of the dielectric layer. On the top surface side of the dielectric layer, a portion of the emitter section in the vicinity of the peripheral edge of the first electrode is exposed to the outside of the piezoelectric-film-type electron emitter (i.e., to the aforementioned reduced-pressure atmosphere). The piezoelectric-film-type electron emitter is configured so that the thus-exposed portion serves as an electron emission region, which plays an important role for electron emission in the electron emitter.

The piezoelectric-film-type electron emitter having the aforementioned configuration is operated as follows. Firstly, in the first stage, voltage is applied between the first electrode and the second electrode so that the first electrode is higher in electric potential. An electric field generated by the applied voltage brings the emitter section into a predetermined polarization state. Subsequently, in the second stage, voltage is applied between the first electrode and the second electrode so that the first electrode is lower in electric potential. Through this voltage application, the polarization of the emitter section is inverted, and electrons are accumulated on the electron emission region. Subsequently, in the third stage, voltage is again applied so that the first electrode is higher in electric potential. Through this voltage application, the polarization of the emitter section is re-inverted. With this polarization inversion, the electrons accumulated on the electron emission region are emitted from the emitter section by means of electrostatic repulsion between the electrons and dipoles, and the thus-emitted electrons fly in the aforementioned reduced-pressure atmosphere. Thus, the piezoelectric-film-type electron emitter emits electrons.

### SUMMARY OF THE INVENTION

The aforementioned conventional piezoelectric-film-type electron emitter involves a problem in that electron emission quantity is considerably reduced with repeated use thereof.

Among components of the piezoelectric-film-type electron emitter (i.e., the emitter section, the first electrode, the second electrode, and the substrate which supports the emitter section and the electrodes), the emitter section would generally undergo change in characteristics with repeated use of the electron emitter. Therefore, reduction in electron emission quantity is considered to be caused mainly by impairment of the emitter section with repeated use of the piezoelectric-film-type electron emitter.

As described above, such a conventional dielectric element (e.g., a piezoelectric-film-type electron emitter) involves a problem in that a dielectric layer is impaired with repeated use of the element, and impairment of the dielectric layer considerably deteriorates element characteristics.

In view of the foregoing, the present inventors have conducted extensive studies, and as a result have found that when the aforementioned dielectric element is driven at a temperature lower, to some extent (several tens of degrees (or about 20 to about 70 degrees)), than the Curie temperature of the aforementioned dielectric layer, deterioration of characteristics of the element due to repeated use thereof is suppressed. In addition, the present inventors have suggested that when the above-described temperature almost corresponds to the temperature at which the dielectric element is used in practice (i.e., the temperature which the dielectric element or the dielectric layer reaches during driving of the element: 100° C. or lower (e.g., room temperature to 50° C. or thereabouts)), deterioration of characteristics of the element due to repeated use thereof is suppressed; i.e., the element exhibits enhanced durability.

The present invention provides a dielectric element, and a characteristic feature of the dielectric element resides in that the element comprises a dielectric layer containing, as a primary component, a composition represented by the following formula (1):

Pb(Mg_{1/3}Nb_{2/3})ₐTi_{b}Zr_{c}O₃ (1)

[wherein 0.2≦a≦0.375, 0.25≦b≦0.43, 0.25≦c≦0.375, and a+b+c=1], and having a Curie temperature Tc (° C.) falling within a range of 60≦Tc≦150 (preferably 70≦Tc≦150).

In the primary component of the aforementioned dielectric layer, 8 to 16 mol % of lead may be substituted by strontium. That is, the dielectric layer may contain, as a primary component, a composition represented by the following formula (2):

Pb₁₋ₓSrₓ(Mg_{1/3}Nb_{2/3})ₐTi_{b}Zr_{c}O₃ (2)

[wherein 0.08≦x≦0.16, 0.2≦a≦0.375, 0.25≦b≦0.43, 0.25≦c≦0.375, and a+b+c=1], and may have a Curie temperature Tc (° C.) falling within a range of 60≦Tc≦150.

With this configuration, deterioration of characteristics of the dielectric element due to repeated use thereof is suppressed; i.e., the dielectric element exhibits enhanced durability.

The aforementioned dielectric layer may contain manganese in an amount of 0.2 to 1.0 wt. % as reduced to MnO₂. Through addition of manganese, the dielectric element can exhibit high durability, as well as high driving performance.

The dielectric element of the present invention, which has the aforementioned characteristic configuration, is suitably applicable to an electron emitter. Particularly, the dielectric element of the present invention is suitably applicable to a light source device which is continuously or intermittently driven over a relatively long period of time, such as an FED or a light source for a liquid crystal display backlight.

The present invention also provides an electron emitter comprising an emitter layer, a first electrode, and a second electrode. The emitter layer is formed of the aforementioned dielectric layer, and is configured so that when a predetermined driving electric field is applied to the emitter layer in a reduced-pressure atmosphere, electrons are emitted therefrom toward the atmosphere. The first and second electrodes are provided on the emitter layer so as to apply the driving electric field to the emitter layer.

The electron emitter of the present invention is configured so that when the aforementioned driving electric field is applied to the emitter layer through application of a predetermined drive voltage between the first and second electrodes, electrons are emitted from the emitter layer toward the aforementioned reduced-pressure atmosphere.

Specifically, a characteristic feature of the electron emitter of the present invention resides in that the emitter layer is formed of the aforementioned dielectric layer.

According to the present invention, impairment of the dielectric layer (the emitter layer) due to repeated use thereof is suppressed. Therefore, even when the dielectric element or electron emitter provided by the present invention is repeatedly employed, deterioration of characteristics thereof is suppressed; i.e., the dielectric element or electron emitter exhibits enhanced durability.

The dielectric layer constituting the emitter layer may contain manganese in an amount of 0.2 to 1.0 wt. % as reduced to MnO₂. Through addition of manganese, durability is enhanced, and electron emission quantity is increased.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a cross-sectional view schematically showing a display to which an electron emitter according to an embodiment of the present invention is applied;

FIG. 2 is an enlarged cross-sectional view showing essential portions of the electron emitter of FIG. 1;

FIG. 3 shows an equivalent circuit of the electron emitter of FIG. 1;

FIG. 4 shows another equivalent circuit of the electron emitter of FIG. 1;

FIG. 5 is a diagram showing the waveform of a drive voltage Va applied to the electron emitter of FIG. 1;

FIGS. 6A to 6C are schematic representations for explaining operation of the electron emitter of FIG. 1;

FIGS. 7A to 7C are schematic representations for explaining operation of the electron emitter of FIG. 1; and

FIG. 8 shows the Q-V hysteresis of a dielectric material.

### DETAILED DESCRIPTION OF PREFERRED EMBODIMENTS

A preferred embodiment of the electron emitter of the present invention will next be described with reference to the drawings and tables. The material and structure of components of the electron emitter of the present invention will be described with reference to one typical embodiment, for the sake of readily understandable and consistent illustration. Modifications of the material and structure of the components of the electron emitter according to the embodiment will be collectively described after description of the configuration, operation, and effect of the electron emitter according to the embodiment.

### <Schematic Description of FED Including Electron Emitter>

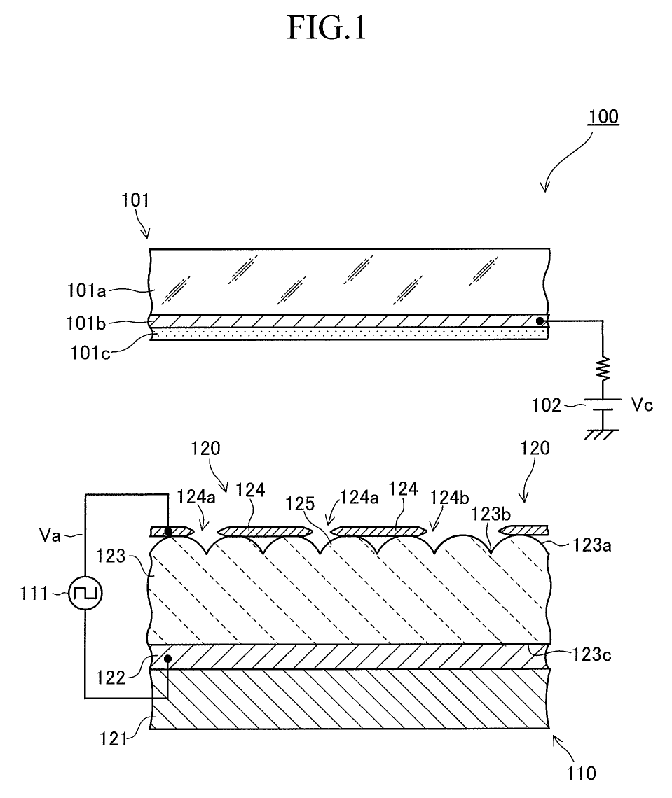

FIG. 1 is a cross-sectional view schematically showing a display 100, which is an FED to which the electron emitter according to the present embodiment is applied.

As shown in FIG. 1, the display 100 includes a light-emitting panel 101. The light-emitting panel 101 includes a transparent plate 101a, a collector electrode 101b, and a phosphor layer 101c.

The transparent plate 101a is formed of a glass plate or an acrylic plate. The collector electrode 101b is formed on the surface on the lower side (as viewed in FIG. 1) of the transparent plate 101a. The collector electrode 101b is formed of a transparent electrode such as an indium tin oxide (ITO) thin film.

The phosphor layer 101c is formed on the lower surface of the collector electrode 101b. The phosphor layer 101c is configured so that when electrons flying toward the collector electrode 101b, which is connected to a bias voltage source 102 via a predetermined resistor, collide with the phosphor layer 101c, fluorescence can be emitted. The bias voltage source 102 is configured so as to apply a predetermined collector voltage Vc between the ground and the collector electrode 101b.

As shown in FIG. 1, an electron-emitting device 110 is provided below the light-emitting panel 101. The electron-emitting device 110 is electrically connected to a pulse generator 111. The electron-emitting device 110 is configured so that when a drive voltage Va is applied thereto by means of the pulse generator 111, electrons are emitted toward the light-emitting panel 101 (the collector electrode 101b and the phosphor layer 101c).

A predetermined space is provided between the electron-emitting device 110 and the light-emitting panel 101 (phosphor layer 101c). The space between the electron-emitting device 110 and the phosphor layer 101c is a reduced-pressure atmosphere having a predetermined vacuum level of, for example, 10² to 10⁻⁶ Pa (more preferably 10⁻³ to 10⁻⁵ Pa).

The display 100 is configured so that electrons are emitted, to the reduced-pressure atmosphere, from the electron-emitting device 110 through application of the drive voltage Va to the device 110 by means of the pulse generator 111, and that, by means of an electric field generated through application of the collector voltage Vc, the thus-emitted electrons fly toward the collector electrode 101b and collide with the phosphor layer 101c, whereby fluorescence is emitted.

### <Configuration of Electron-Emitting Device>

The electron-emitting device 110 is configured so as to have a thin flat plate shape. The electron-emitting device 110 includes a number of two-dimensionally arranged electron emitters 120 according to the present embodiment.

Each of the electron emitters 120 includes a substrate 121, a lower electrode 122, an emitter layer 123, and an upper electrode 124. The substrate 121 is formed of a heat-resistant glass thin plate or a ceramic thin plate. The lower electrode 122 is formed on the substrate 121. The lower electrode 122 is formed of a metallic film having a thickness of 20 μm or less. The lower electrode 122 is electrically connected to the aforementioned pulse generator 111.

The emitter layer 123 (i.e., the emitter layer (dielectric layer) of the electron emitter of the present invention) is formed on the lower electrode 122 (i.e., the second electrode of the electron emitter of the present invention). In the present embodiment, the emitter layer 123 is formed of a polycrystalline dielectric material having a thickness of 1 to 300 μm (more preferably 5 to 100 μm). The dielectric material contains a primary component (i.e., a dielectric composition), and an additional component.

The primary component may be a ternary solid solution composition of lead magnesium niobate (Pb(Mg_{1/3}Nb_{2/3})O₃, abbreviated as “PMN”), lead titanate (PbTiO₃, abbreviated as “PT”), and lead zirconate (PbZrO₃, abbreviated as “PZ”). The PMN-PT-PZ ternary solid solution composition is represented by the following formula (I):

Pb₁₋ₓSrₓ(Mg_{1/3}Nb_{2/3})ₐTi_{b}Zr_{c}O₃ (I)

[wherein 0.08≦x≦0.16, 0.2≦a≦0.375, 0.25≦b≦0.43, 0.25≦c≦0.375, and a+b+c=1].

In the present embodiment, 8 to 16 mol % of lead of the primary component is substituted by strontium so as to lower the Curie temperature (Tc) of the emitter layer 123 (in particular, 37.5PMN-25PT-37.5PZ or an almost equivalent composition) to a temperature (60° C. to 150° C.), which is higher, to some extent, than the temperature at which the electron emitter is used in practice.

As used herein, the expression “37.5PMN-25PT-37.5PZ” is an abbreviation of a lead magnesium niobate (PMN)-lead titanate (PT)-lead zirconate (PZ) ternary solid solution composition (PMN:PT:PZ=37.525:37.5 (by mole)) (the same shall apply hereinafter).

The aforementioned additional component is preferably manganese, iron, chromium, cobalt, molybdenum, tungsten, or the like. The amount of such an additional component added may be reduced to the amount of the corresponding oxide (e.g., manganese dioxide (MnO₂), ferric oxide (Fe₂O₃), chromic oxide (Cr₂O₃), tricobalt tetroxide (Co₃O₄), molybdenum trioxide (MoO₃), or tungsten trioxide (WO₃)).

When incorporated into the emitter layer 123, such an additional component forms a transition metal oxide of high oxidation number which can serve as an oxidizing agent by being converted into an oxide of the transition metal of lower oxidation number. That is, such an additional component exhibits the effect of suppressing precipitation of metallic lead in the emitter layer 123, thereby suppressing deterioration of characteristics of the electron emitter with repeated use thereof.

When the aforementioned additional component is manganese, characteristics (e.g., mechanical quality factor (Qm)) of the emitter layer 123 (i.e., dielectric layer) are improved, and thus electron emission quantity is increased, which is preferred. In this case, the amount of manganese added is preferably determined to be 0.2 to 1.0 wt. % as reduced to manganese dioxide (MnO₂).

Microscopic concavities and convexities due to, for example, crystal grain boundaries are formed on an upper surface 123a of the emitter layer 123. Specifically, numerous concavities 123b are formed on the upper surface 123a. The upper surface 123a is formed so as to have a surface roughness Ra (centerline average roughness, unit: μm) of 0.005 to 3.0.

The emitter layer 123 is formed on the lower electrode 122 such that a lower surface 123c of the layer 123, which is opposite the upper surface 123a, is in contact with the lower electrode 122. The upper electrode 124 is formed on the upper surface 123a of the emitter layer 123. The upper electrode 124 is electrically connected to the aforementioned pulse generator 111.

The upper electrode 124 (i.e., the first electrode of the electron emitter of the present invention) is formed of a thin layer of an electrically conductive material (thickness: about 0.1 to about 20 μm). Examples of the electrically conductive material which may be employed for forming the upper electrode 124 include metallic film, metallic particles, electrically conductive non-metallic film (e.g., carbon film or electrically conductive non-metallic oxide film), and electrically conductive non-metallic particles (e.g., carbon particles or electrically conductive oxide particles).

The aforementioned metallic film or metallic particles are preferably made of platinum, gold, silver, iridium, palladium, rhodium, molybdenum, tungsten, or an alloy thereof. The aforementioned electrically conductive non-metallic film or electrically conductive non-metallic particles are preferably made of graphite, ITO (indium tin oxide), or LSCO (lanthanum strontium cobalt oxide). When the upper electrode 124 is formed of metallic particles or electrically conductive non-metallic particles, preferably, the particles are in a scale-like, plate-like, foil-like, acicular, rod-like, or coil-like form.

The upper electrode 124 has a plurality of openings 124a. The openings 124a are formed such that the upper surface 123a of the emitter layer 123 is exposed to the outside of the electron-emitting device 110 (i.e., the aforementioned reduced-pressure atmosphere; the same shall apply hereinafter). The upper surface 123a of the emitter layer 123 is exposed to the outside of the electron-emitting device 110 also at peripheral edge portions 124b of the upper electrode 124. A portion of the emitter layer 123 exposed to the outside of the electron-emitting device 110 constitutes an emitter section 125, which serves as a main section for electron emission.

As described hereinbelow, the electron emitter 120 is configured so that electrons supplied from the upper electrode 124 are accumulated on the emitter section 125, and the thus-accumulated electrons are emitted toward the outside of the electron-emitting device 110 (i.e., toward the phosphor layer 101c).

### <Detailed Description of Electron Emitter>

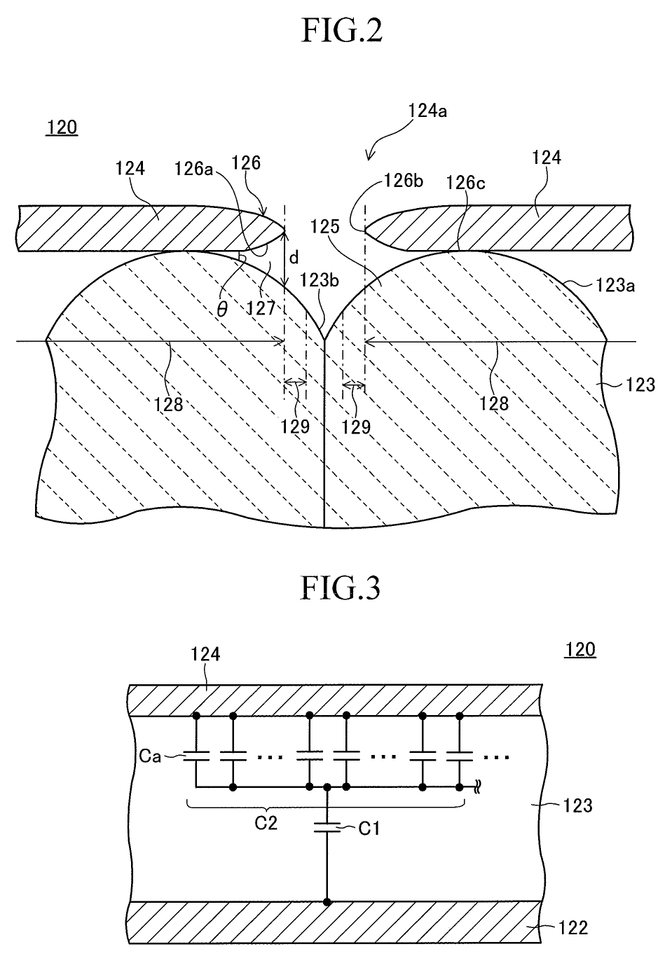

FIG. 2 is an enlarged cross-sectional view showing essential portions of the electron emitter 120 of FIG. 1. In the case shown in FIG. 1 or 2, the concavities 123b and the openings 124a are formed in one-to-one correspondence. However, in some cases, a plurality of concavities 123b may be formed in a single opening 124a, or no concavities 123b may be formed in an opening 124a.

As shown in FIG. 2, in the upper electrode 124, a peripheral portion 126, which is a portion in the vicinity of the opening 124a, is provided so as to overhang the emitter section 125 (hereinafter the portion may be referred to as an “overhanging portion”). Specifically, the overhanging portion 126 is formed such that a lower surface 126a and a tip end 126b of the overhanging portion 126 are apart from the upper surface 123a of the emitter layer 123 corresponding to the emitter section 125. The overhanging portion 126 is also formed at positions corresponding to the peripheral edge portions 124b (see FIG. 1) of the upper electrode 124.

A triple junction 126c is formed at a position at which the overhanging portion 126 is in contact with the upper surface 123a of the emitter layer 123; i.e., at a position at which the emitter layer 123 is in contact with the upper electrode 124 and the aforementioned reduced-pressure atmosphere.

The triple junction 126c is a site (electric field concentration point) at which lines of electric force concentrate (where electric field concentration occurs) when, as shown in FIG. 1, a drive voltage Va is applied between the lower electrode 122 and the upper electrode 124. As used herein, the expression “site at which lines of electric force concentrate” refers to a site at which lines of electric force that are generated from the lower electrode 122 at even intervals concentrate, when the electric force lines are drawn under the assumption that the lower electrode 122, the emitter layer 123, and the upper electrode 124 are flat plates each having a cross section extending infinitely. The state of concentration of lines of electric force (i.e., the state of electric field concentration) can be readily observed through simulation by means of numerical analysis employing the finite-element method.

As shown in FIG. 2, a gap 127 is formed between the lower surface 126a and tip end 126b of the overhanging portion 126 and the upper surface 123a (emitter section 125) of the emitter layer 123. The gap 127 is formed such that the maximum gap distance d satisfies the following relation: 0 μm<d≦10 μm, and the angle θ between the lower surface 126a and the surface of the emitter section 125 satisfies the following relation: 0°<θ≦60°.

The tip end 126b of the overhanging portion 126 has such a shape as to serve as the aforementioned electric field concentration point. Specifically, the overhanging portion 126 has such a cross-sectional shape as to be acutely pointed toward the tip end 126b of the portion 126; i.e., the thickness gradually decreases.

The openings 124a may be formed to assume a variety of shapes as viewed in plane (as viewed from above in FIG. 2), including a circular shape, an elliptical shape, a polygonal shape, and an irregular shape. The openings 124a are formed such that the average of diameters of the openings 124a as viewed in plane is 0.1 μm to 20 μm. The reason for this is described below. As used herein, the expression “the average of diameters of the openings 124a” refers to the number-based average of diameters of circles having areas identical to those of the openings 124a.

As shown in FIG. 2, regions of the emitter layer 123 where polarization is inverted in accordance with application of the aforementioned drive voltage (drive voltage Va shown in FIG. 1) are first regions 128 and second regions 129. The first regions 128 correspond to regions facing the upper electrode 124. The second regions 129 correspond to regions of the openings 124a that extend from the tip ends 126b of the overhanging portions 126 toward the centers of the openings 124a. The range of the second regions 129 varies depending on the level of the drive voltage Va and the degree of electric field concentration in the vicinity of the second regions 129.

When the average diameter of the openings 124a falls within the above-described range (i.e., 0.1 μm to 20 μm), a sufficient quantity of electrons are emitted through the openings 124a, and high electron emission efficiency is secured.

When the average diameter of the openings 124a is less than 0.1 μm, the area of the second regions 129 decreases. The second regions 129 constitute primary regions of the emitter section 125 which temporarily accumulates electrons supplied from the upper electrode 124 and then emits the electrons. Therefore, a decrease in area of the second regions 129 reduces the quantity of electrons emitted. In contrast, when the average diameter of the openings 124a exceeds 20 μm, the ratio of the second regions 129 to the entirety of the emitter section 125 (occupancy of the second regions) decreases, resulting in low electron emission efficiency.

### <Equivalent Circuit of Electron Emitter>

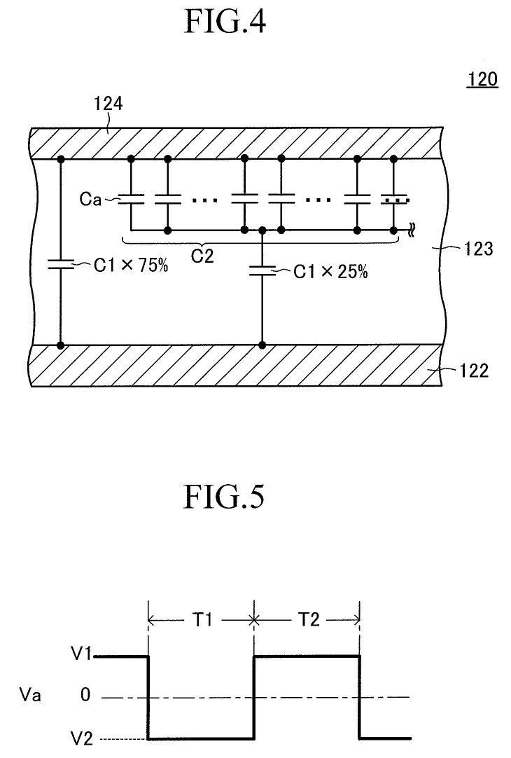

FIGS. 3 and 4 show equivalent circuits of the electron emitter 120 of FIG. 1.

Most briefly, the configuration of the electron emitter 120 according to the present embodiment can be approximated to an equivalent circuit as shown in FIG. 3. “C1” of FIG. 3 is a capacitor formed by sandwiching the emitter layer 123 between the lower electrode 122 and the upper electrode 124. “Ca” of FIG. 3 is a capacitor formed by any of the gaps 127 (see FIG. 2). “C2” of FIG. 3 is a capacitor formed of an aggregate of a plurality of capacitors Ca, which are connected in parallel. The capacitor C1 associated with the emitter layer 123 is connected in series to the capacitor C2 associated with the gaps 127 (see FIG. 2).

However, the equivalent circuit, in which the capacitor C1 associated with emitter layer 123 is connected in series to the capacitor C2 formed of the aggregate of the capacitors Ca, is not practical. In practice, conceivably, the percentage of a portion of the capacitor C1 associated with the emitter layer 123 that is connected in series to the capacitor C2 formed of the capacitor aggregate varies with, for example, the number and area of the openings 124a (see FIG. 2) formed in the upper electrode 124.

Capacitance will now be calculated under the assumption that, for example, 25% of the capacitor C1 associated with the emitter layer 123 is connected in series to the capacitor C2 as shown in FIG. 4.

Conditions of the calculation are as follows: the gaps 127 are in a vacuum (i.e., specific dielectric constant ∈ᵣ=1); the maximum gap d of the gaps 127 is 0.1 μm; the area S of a region corresponding to a single gap 127 is 1 μm×1 μm; the number of the gaps 127 is 10,000; the specific dielectric constant of the emitter layer 123 is 2,000; the thickness of the emitter layer 123 is 20 μm; and the facing area between the lower electrode 122 and the upper electrode 124 is 200 μm×200 μm.

Under the above-described conditions, the capacitance of the capacitor C1 is 35.4 pF, and the capacitance of the capacitor C2 is 0.885 pF. The overall capacitance between the upper electrode 124 and the lower electrode 122 is 27.5 pF, which is lower than the capacitance of the capacitor C1 associated with the emitter layer 123 (i.e., 35.4 pF); i.e., the overall capacitance is 78% the capacitance of the capacitor C1.

As described above, the overall capacitance of the capacitor C2 formed of the aggregate of the capacitors Ca associated with the gaps 127 (see FIG. 2) is considerably lower than the capacitance of the capacitor C1 (associated with the emitter layer 123) which is connected in series to the capacitor C2. Therefore, when the drive voltage Va is applied to this series circuit, most of the voltage Va is applied to the capacitors Ca (C2), whose capacitance is lower than that of the capacitor C1. In other words, most of the drive voltage Va is applied to the gaps 127 (see FIG. 2). This attains an increase in output of the electron emitter.

As described above, the capacitor C1 associated with the emitter layer 123 is connected in series to the capacitor C2 formed of the aggregate of the capacitors Ca associated with the gaps 127 (see FIG. 2). Therefore, the overall capacitance of this series circuit is lower than the capacitance of the capacitor C1 associated with the emitter layer 123. Therefore, the electron emitter exhibits a preferred property (i.e., reduction in overall power consumption).

### <Electron Emission Principle of Electron Emitter>

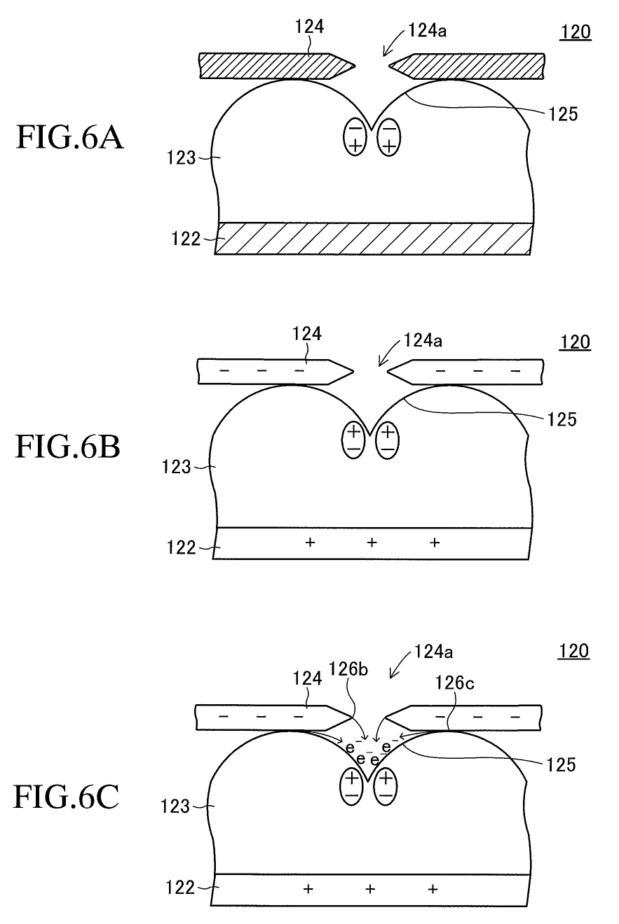

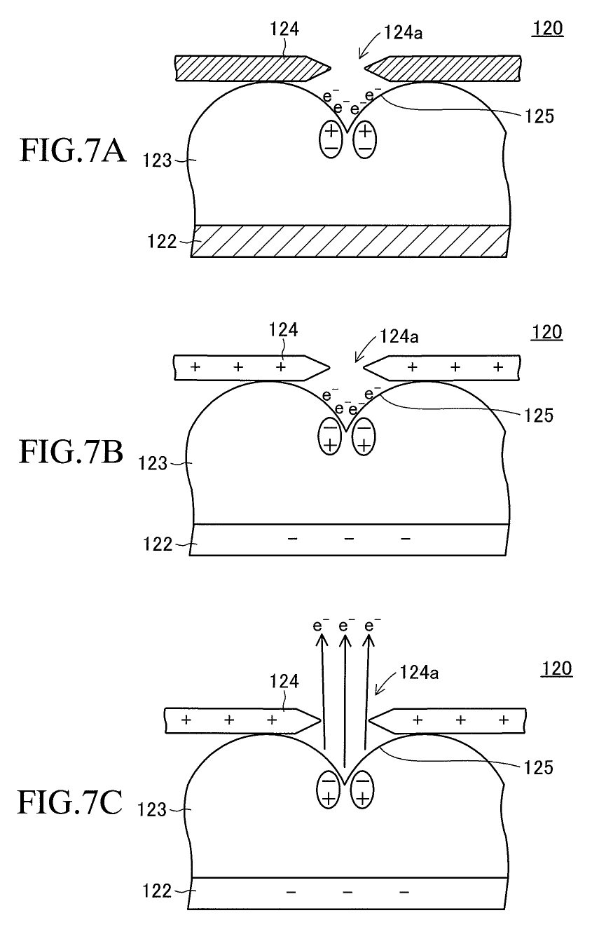

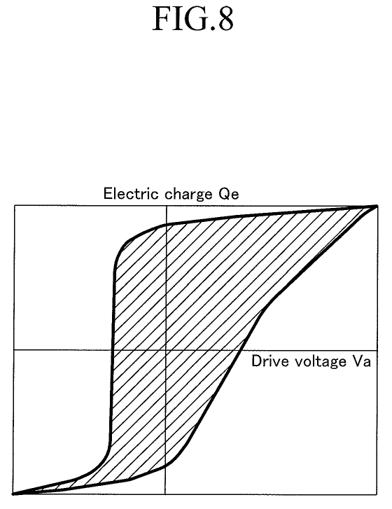

FIG. 5 is a diagram showing the waveform of a drive voltage Va applied to the electron emitter 120 shown in FIG. 1. FIGS. 6 and 7 each show the state of operation of the electron emitter 120 of FIG. 1 in the case where the drive voltage Va shown in FIG. 5 is applied to the electron emitter 120. Next will be described the principle of electron emission of the electron emitter 120 with reference to FIGS. 5 to 7.

In the present embodiment, as shown in FIG. 5, the drive voltage Va applied is an alternating voltage of rectangular waveform (period: T1+T2). In the drive voltage Va, the reference voltage (voltage corresponding to the center of the wave) is 0 V.

As shown in FIGS. 5 to 7, in the drive voltage Va, during time T1 corresponding to the first stage, the electric potential of the upper electrode 124 is V2 (negative voltage), which is lower than the electric potential of the lower electrode 122; and during time T2 corresponding to the second stage, the electric potential of the upper electrode 124 is V1 (positive voltage), which is higher than the electric potential of the lower electrode 122.

As shown in FIG. 6A, in the initial state, the emitter section 125 is polarized unidirectionally, and the negative poles of dipoles face toward the upper surface 123a of the emitter layer 123.

Firstly, in the initial state, in which the reference voltage is applied, as shown in FIG. 6A, the emitter section 125 is polarized such that the negative poles of dipoles face toward the upper surface 123a of the emitter layer 123. In this state, virtually no electrons are accumulated on the emitter section 125.

Subsequently, as shown in FIG. 6B, when the negative voltage V2 is applied, polarization is inverted. This inversion of polarization causes electric field concentration to occur at the aforementioned electric field concentration points. Through this electric field concentration, electrons are supplied from the electric field concentration points of the upper electrode 124 toward the emitter section 125, and then, as shown in FIG. 6C, electrons are accumulated on the emitter section 125. In other words, the emitter section 125 is electrically charged. This electrical charging can be continued until a predetermined saturated condition, which depends on the surface resistance of the emitter layer 123, is attained. The quantity of the charge can be controlled on the basis of control voltage application time or voltage waveform. Thus, the upper electrode 124 (in particular, the aforementioned electric field concentration points) functions as an electron supply source for the emitter section 125.

Subsequently, when the drive voltage Va is changed to the reference voltage as shown in FIG. 7A, and then the positive voltage V1 is applied as shown in FIG. 7B, polarization is re-inverted. As a result, electrostatic repulsion between the accumulated electrons and the negative poles of dipoles causes the electrons to be emitted from the emitter section 125 toward the outside of the electron emitter 120 through the opening 124a as shown in FIG. 7C.

In a manner similar to that described above, electrons are emitted from the peripheral edge portions 124b (see FIG. 1) of the upper electrode 124.

### EXAMPLES

Next will be described electron emitters 120 (emitter layers 123) of the Examples having the aforementioned configuration with reference to the results of evaluation of the electron emitters. The electron emitters 120 (emitter layers 123) of the Examples were evaluated on the basis of change in the below-described “electron emission efficiency.”

As shown in FIG. 1, when Va represents drive voltage applied between the lower electrode 122 and the upper electrode 124; Vc represents electron accelerating voltage (collector voltage) of a bias voltage source 102 for generating an external electric field which causes electrons emitted from the electron emitter 120 to fly toward a light-emitting panel 101; i_{c} represents current due to the electrons emitted from the electron emitter 120 (i.e., current which flows between the bias voltage source 102 and a collector electrode 101b); and P represents drive power for the electron emitter 120, electron emission efficiency η is represented by the following formula:

η=Vc×i_{c}(P+Vc×i_{c})

(wherein drive power P=[hysteresis loss of electron emitter: P1]+[resistance loss in drive circuit: P2]). P1 is the area enclosed by the Q-V hysteresis loop shown in FIG. 8 (i.e., the area of the shaded portion shown in FIG. 8). P2, which varies with the method for operating the electron emitter, is represented by the following inequality: 0≦P2≦(drive voltage Va×electric charge Qe)−(the area enclosed by the Q-V hysteresis loop)=(the area of a portion outside the shaded portion shown in FIG. 8). In this inequality, 0 on the left side corresponds to the case where the electron emitter 120 is operated so that the drive power satisfies the Q-V hysteresis.

In each of the Examples, electron emission efficiency η₀ (initial value) was obtained immediately after production of the electron emitter 120, and electron emission efficiency η₁ was obtained after the emitter 120 was operated predetermined times. The electron emitter 120 was evaluated on the basis of the ratio r (η₁/η₀).

Table 1 shows compositions and characteristic values of the electron emitters (emitter layers) of the Examples and Comparative Examples.

In Table 1, “PMN” represents the mole fraction (mol %) of PMN contained in the aforementioned primary component (i.e., PMN-PT-PZ ternary solid solution composition) of the emitter layer 123, and corresponds to a value obtained by multiplying the value “a” of formula (I) by 100. Similarly, “PT” corresponds to a value obtained by multiplying the value “b” of formula (I) by 100, and “PZ” corresponds to a value obtained by multiplying the value “c” of formula (I) by 100.

In Table 1, “Sr” represents the amount (mol %) of strontium substituting for lead of the aforementioned primary component, and corresponds to a value obtained by multiplying the value “x” of formula (I) by 100. “Mn” represents the amount (wt. %) of added manganese as reduced to MnO₂.

In Example 1, the aforementioned primary component contains, as a matrix, 37.5PMN-25PT-37.5PZ (wherein 8 mol % of lead of the matrix is substituted by strontium), and contains manganese in an amount of 0.2 wt. % as reduced to manganese dioxide (MnO₂) (the primary component will be abbreviated as “37.5PMN-25PT-37.5PZ/8Sr+0.2 wt % MnO₂,” the same shall apply hereinafter).

TABLE 1

| | PMN | PT | PZ | Sr | Mn | Tc |
|---|---|---|---|---|---|---|
| | (mol %) | (mol %) | (mol %) | (mol %) | (MnO₂ wt %) | (° C.) |
| Example 1 | 37.5 | 25 | 37.5 | 8 | 0.2 | 138 |
| Example 2 | 37.5 | 25 | 37.5 | 10 | 1 | 125 |
| Example 3 | 37.5 | 25 | 37.5 | 12 | 1 | 106 |
| Example 4 | 37.5 | 25 | 37.5 | 14 | 1 | 88 |
| Example 5 | 37.5 | 25 | 37.5 | 16 | 1 | 73 |
| Compar- | 37.5 | 25 | 37.5 | 18 | 1 | 56 |
| ative | | | | | | |
| Example 1 | | | | | | |
| Compar- | 37.5 | 25 | 37.5 | 20 | 1 | 43 |
| ative | | | | | | |
| Example 2 | | | | | | |

Table 2 shows the results of evaluation, through the aforementioned method, of the electron emitters of the Examples and Comparative Examples, each including the emitter layer having the composition shown in Table 1. Ratio r shown in Table 2 was determined by use of electron emission efficiency η₁ obtained after the electron emitter was operated 1×10⁹ pulses.

TABLE 2

| | η₀ (%) | r = η₁/η₀ (%) |
|---|---|---|
| Example 1 | 60 | 50 |
| Example 2 | 60 | 52 |
| Example 3 | 62 | 60 |
| Example 4 | 62 | 61 |
| Example 5 | 58 | 58 |
| Comparative Example 1 | 16 | 70 |
| Comparative Example 2 | 15 | — |

As is clear from Table 2, high initial values η₀ and ratios r were attained in Examples 1 to 5, in which the amount of lead substituted by strontium fell within a range of 8 to 16%, and the Curie temperature (Tc) of the emitter layer fell within a range of 60° C. (or 70° C.) to 150° C., which is higher, to some extent, than the temperature at which the electron emitter is used in practice; i.e., 50° C. or thereabouts.

In contrast, in Comparative Example 1, in which the amount of lead substituted by strontium was 18%, and the Curie temperature (Tc) of the emitter layer was lower than 60° C., the ratio r was high, but the initial value η₀ was very low (in Comparative Example 2, the ratio r could not be determined due to excessively low initial value η₀).

In Example 3, in which 37.5PMN-25PT-37.5PZ/12Sr+1 wt % MnO₂ was employed (Tc=106° C.), or in Example 4, in which 37.5PMN-25PT-37.5PZ/14Sr+1 wt % MnO₂ (Tc=88° C.) was employed, the initial value η₀ and the ratio r were considerably high. That is, in the case where the amount of lead substituted by strontium falls within a range of 12 to 15%, and the Curie temperature (Tc) of the emitter layer falls within a range of 80° C. to 110° C., the most excellent characteristics are obtained.

As described above, in each Example, high initial electron emission efficiency is attained through addition of manganese. In addition, through substitution of lead by strontium and addition of manganese, reduction in electron emission efficiency, which is due to repeated use of the electron emitter, is effectively suppressed, and electron emission efficiency per se is improved.

When the amount of manganese added is small (1% or less as reduced to MnO₂; for example, about 0.2% as in the case of Example 1), addition of manganese less contributes to an increase in Curie temperature. Therefore, in such a case, the amount of lead substituted by strontium is preferably about 8 to about 10 mol %.

### <Modifications>

The aforementioned embodiment and Examples are merely typical embodiment and Examples of the present invention which have been considered best by the present applicant at the time when the present application has been filed. Thus, the present invention is not limited to the aforementioned embodiment and Examples. Therefore, it should be understood that various modifications of the aforementioned embodiment and Examples may be made so long as the essentials of the present invention are not changed.

Several modifications will next be described. In the below-described modifications, members having configuration and function similar to those described in the aforementioned embodiment are denoted by the same reference numerals as those employed in the embodiment. Description of the embodiment can be applied to description of such members, so long as these descriptions do not technically contradict each other.

Needless to say, modifications of the aforementioned embodiment are not limited to the below-described ones. Meanwhile, a plurality of modifications may be appropriately employed in combination, so long as these modifications do not technically contradict one another.

(i) Application of the electron emitter of the present invention is not limited to FEDs. The configuration of the electron emitter of the present invention is not limited to that described in the aforementioned embodiment.

For example, in the electron emitter 120 according to the aforementioned embodiment, the lower electrode 122 is formed on the lower surface 123c of the emitter layer 123, and the upper electrode 124 is formed on the upper surface 123a of the emitter layer 123. However, the present invention is not limited to this configuration, and is suitably applicable to a configuration in which both a first electrode and a second electrode are formed on the upper surface 123a of the emitter layer 123.

(ii) The substrate 121 may be made of a metal in place of a glass or ceramic material. No particular limitation is imposed on the type of the ceramic material constituting the substrate 121. However, from the viewpoints of heat resistance, chemical stability, and insulating property, the substrate 121 is preferably made of a ceramic material containing at least one species selected from the group consisting of stabilized zirconium oxide, aluminum oxide, magnesium oxide, mullite, aluminum nitride, silicon nitride, and glass. More preferably, the substrate 121 is made of stabilized zirconium oxide, from the viewpoints of high mechanical strength and excellent toughness.

As used herein, the term “stabilized zirconium oxide” refers to zirconium oxide in which crystal phase transition is suppressed through addition of a stabilizer. The stabilized zirconium oxide encompasses partially stabilized zirconium oxide. Examples of the stabilized zirconium oxide which may be employed include zirconium oxide containing a stabilizer (e.g., calcium oxide, magnesium oxide, yttrium oxide, scandium oxide, ytterbium oxide, cerium oxide, or an oxide of a rare earth metal) in an amount of 1 to 30 mol %. From the viewpoint of considerable enhancement of mechanical strength, zirconium oxide containing yttrium oxide as a stabilizer is preferred. In this case, the yttrium oxide content is preferably 1.5 to 6 mol %, more preferably 2 to 4 mol %. Zirconium oxide containing, in addition to yttrium oxide, aluminum oxide in an amount of 0.1 to 5 mol % is preferably employed.

The stabilized zirconium oxide may have, for example, a cubic-monoclinic crystal phase, a tetragonal-monoclinic crystal phase, or a cubic-tetragonal-monoclinic crystal phase. From the viewpoints of strength, toughness, and durability, the stabilized zirconium oxide preferably has, as a primary crystal phase, a tetragonal crystal phase or a tetragonal-cubic crystal phase.

(iii) A variety of materials and methods other than those described above in the Examples may be employed for forming the emitter layer 123. For example, the primary component of the emitter layer 123 is not limited to 37.5PMN-25PT-37.5PZ. Specifically, 37.5PMN-37.5PT-25PZ, 20PMN-43PT-37PZ, and compositions almost equivalent thereto may be suitably employed. That is, all the compositions represented by the aforementioned formula may be suitably employed.

The emitter layer 123 may be formed through a generally employed dielectric film formation technique, such as screen printing, dipping, application, electrophoresis, aerosol deposition, the ion beam method, sputtering, vacuum deposition, ion plating, chemical vapor deposition (CVD), the green sheet method, the alkoxide method, or the coprecipitation method. If necessary, the emitter layer 123 may be appropriately subjected to thermal treatment.

The amount of manganese added may be on the basis of, in place of manganese dioxide (MnO₂), manganese monoxide (MnO) or manganese carbonate (MnCO₃).

(iv) Operational and functional elements constituting means for achieving the objects of the present invention encompass, in addition to specific structures disclosed in the aforementioned embodiment, Examples, and modifications, any structure capable of attaining the operation and function of the present invention.

What is claimed is:

1. An electron emitter comprising:
an emitter layer formed of a dielectric layer containing, as a primary component, a composition represented by the following formula:
Pb(Mg_{1/3}Nb_{2/3})ₐTi_{b}Zr_{c}O₃
[wherein 0.2≦a≦0.375, 0.25≦b≦0.43, 0.25≦c≦0.375, and a+b+c=1], and having a Curie temperature Tc (° C.) falling within a range of 60≦Tc≦150, the emitter layer being configured so that when a predetermined driving electric field is applied thereto in a reduced-pressure atmosphere, the emitter layer emits electrons toward the atmosphere; and
first and second electrodes provided on the emitter layer so as to apply the driving electric field to the emitter layer, the electron emitter being configured so that when the driving electric field is applied to the emitter layer through application of a predetermined drive voltage between the first electrode and the second electrode, electrons are emitted from the emitter layer toward the reduced-pressure atmosphere.

2. An electron emitter according to claim 1, wherein the dielectric layer constituting the emitter layer contains manganese in an amount of 0.2 to 1.0 wt. % as reduced to MnO₂.

3. An electron emitter according to claim 2, wherein, in the primary component of the dielectric layer constituting the emitter layer, 8 to 16 mol % of lead is substituted by strontium.

4. An electron emitter according to claim 1, wherein, in the primary component of the dielectric layer constituting the emitter layer, 8 to 16 mol % of lead is substituted by strontium.

5. A dielectric element comprising a dielectric layer containing, as a primary component, a composition represented by the following formula:
Pb(Mg_{1/3}Nb_{2/3})ₐTi_{b}Zr_{c}O₃
[wherein 0.2≦a≦0.375, 0.25≦b≦0.43, 0.25≦c≦0.375, and a+b+c=1], and having a Curie temperature Tc (° C.) falling within a range of 60≦Tc≦150.

6. A dielectric element according to claim 5, wherein the dielectric layer contains manganese in an amount of 0.2 to 1.0 wt. % as reduced to MnO₂.

7. A dielectric element according to claim 6, wherein, in the primary component of the dielectric layer, 8 to 16 mol % of lead is substituted by strontium.

8. A dielectric element according to claim 5, wherein, in the primary component of the dielectric layer, 8 to 16 mol % of lead is substituted by strontium.
